(19) United States
(12) Patent Application Publication
(10) Pub. No.: US 2019/0005834 A1
(43) Pub. Date: Jan. 3, 2019

(54) VIRTUAL PATENT APPLICATION

(71) Applicant: Niall R. Lynam, Holland, MI (US)

(72) Inventor: Niall R. Lynam, Holland, MI (US)

(21) Appl. No.: 16/107,171

(22) Filed: Aug. 21, 2018

Related U.S. Application Data
(63) Continuation of application No. 11/623,379, filed on Jan. 16, 2007, now abandoned.
(60) Provisional application No. 60/877,261, filed on Dec. 27, 2006.

(51) Int. Cl. G09B 7/00; G09B 19/18

(52) U.S. Cl. CPC G09B 7/00; G09B 19/18

(57) ABSTRACT

A virtual patent application includes a document having text and drawings. The text and drawings of the document are substantially similar to an actual patent application that has been at least partially prosecuted at a Patent Office. The text and drawings of the document are redacted, modified or masked so as not to be readily recognizable to have been based on the actual patent application.

### CROSS REFERENCE TO RELATED APPLICATIONS

The present application is a continuation of U.S. patent application Ser. No. 11/623,379, filed Jan. 16, 2007, which claims the benefit of U.S. provisional application Ser. No. 60/877,261, filed Dec. 27, 2006, which are hereby incorporated herein by reference in their entireties.

### FIELD OF THE INVENTION

The present invention relates to a method of teaching a class of students in a manner that fosters and stimulates innovation and enhances learning about innovation and, more particularly, relates to a method of teaching a class of students about innovation and about practices and procedures for intellectual property protection of innovation.

### BACKGROUND OF THE INVENTION

Studies show that learning is best achieved when students can readily and immediately apply what is being taught in lectures and in textbooks into hands-on practice and deployment. For example, it is known that learning a foreign language is best facilitated if the students can practice their language skills in day-to-day conversation contemporaneously with what is being taught to them in the class room. Thus, the likes of High School and university/college students best learn a foreign language by spending some time in a country or region where that language is daily spoken. Short intensive courses of several weeks or more, for example, can be made available to students normally resident in the United States who temporarily visit a Spanish-speaking country such as Mexico or Spain to allow the students better learn Spanish by being resident and living in a Spanish-speaking community while they also take classes in Spanish. This allows the students immediately practice what is being learnt in the class room.

No such facility or capability is known for students learning innovation and in particular, learning how to capture and protect innovation via patenting or other forms of intellectual property protection such as protection via copyrights and trademarks. Typically, the likes of undergraduate and graduate-level students, and even others who are attending class-work on innovation and ideation (even later in life or as part of a work-related course or study), do not have the means or opportunity to contemporaneously translate or deploy what they are hearing and learning about via classes into actual intellectual property protection such as via patenting. Thus retention and learning in this arena has hitherto been impaired as the methods of study hitherto known at the likes of colleges and universities for learning about innovation, and how to innovate, and how to capture innovation into intellectual property are largely academic and it often takes many years before the students ever get an opportunity to use what is learnt in the class room in the actual preparation of, application for and prosecution of a patent application (or a trademark or copyright application). Thus students studying courses at colleges and universities in innovation and how to protect innovation via patenting or the like currently lack a method and a process to learn the subject matter in the class room and to contemporaneously deploy what is being learnt into practice.

Therefore, there is a need in the art for a teaching method that overcomes the shortcomings of the prior art.

### SUMMARY OF THE INVENTION

The present invention provides a method of teaching students about intellectual property such as patents, copyrights and trademarks in a manner that enhances their learning thereof and in a manner that provides the students with hands-on experience via the innovative process and teaching method of the present invention. According to the method and process of the present invention, the students of the class can collectively work on the conception of a patentable, copyright-able or trademark-able item, they can participate in and, preferably, undertake the preparation of a patent application, and they can also trace and, preferably, participate in the prosecution of a filed patent application through review of correspondence between the applicant and the patent office and through assistance in preparation of responses to Office Actions and the like, review of prior art, legal research and the like, and also participate in continuation and continuation-in-part applications arising from filings originating from preceding classes in innovation/protection of innovation at the learning institution where the students of the class are attending, and do so in manner that allows that student be scholastically graded and assessed in terms of how well he or she is assimilating or mastering what is being taught by the instructor of the course that the student is taking and that allows that student be scholastically graded and assessed in terms of how well he or she is deploying this learning into actual intellectual property protection practice contemporaneous with the term of the subject class taking the course at the learning institution offering the course.

According to an aspect of the present invention, a method of teaching includes a hands-on method of teaching a class of students about intellectual property, such as patents, copyrights and trademarks, that combines class room learning using the likes of lectures and textbooks with a practical, hands-on workshop associated with the coursework where the class actually conceives an item (such as a patentable design or utility item) or a trademark or a copyrightable item and the class (as part of its course-work and preferably, as part of the scholastic credits each student must work towards, and the grades awarded) actually translates the concept into, for example, a provisional or a utility patent application at a Patent Office or intellectual property office in the relevant jurisdiction—at the United States Patent and Trademark Office (US PTO), for example if in the United States, and/or via a foreign filing such as with the European Patent Office (EPO) or via a WIPO/PCT world patent filing or the like. The method preferably includes preparing a patent application and filing the patent application as part of the class work/course curriculum and with the class of students working individually or as teams or as a class to prosecute a patent application (and most preferably, the prosecution of a patent filing that either originated from that same class or that originated from a previous class at that same college, school, university, institution or entity). The group or class of students are thus taught about patent law and procedures through hands-on experience via conception of a patentable item, via preparation of a patent application and its filing, and via prosecution of a patent application, and this practical learning is conducted in parallel to and is complementary to and is contemporaneous with the study of the theory and techniques of innovation and its protection, via patenting or the like, being taught to the class by an instructor. And the students involved may obtain academic or scholastic ranking and grades/marking/credits via their participation in a patenting or copyrighting or trademarking activity and filing originating from the class being attended and taken. Although illustrated above using a patenting as an example, the method and process of the present invention may also be used in other intellectual property protection of innovation, such as via copyrights and trademarks.

According to an aspect of the present invention, the funding necessary to fund the intellectual property being sought as part of the class in innovation being taught at the learning institution (that may be a university or college or may be an entity or company established to teach courses in innovation) to which the students are registered or attending is provided by the fees paid by the students to attend that institution/register for that course and/or may be via a supplemental fee or surcharge that each student pays to register for the course or be allowed participate in the course and/or may be paid by a sponsor (such as a governmental or non-governmental body interested in fostering innovation such as a law firm or a business entity or a foundation) and/or may be paid for by royalties or other income derived from intellectual property that originated from the course being offered/taught at that learning institution (whether from the subject class or from classes that preceded the subject class and that took the subject course at the learning institution). The subject class may thus continue prosecution of intellectual property filings from previous classes that were filed under the auspices of the institution/course in innovation that the present class is registered as a part of and/or the subject class may innovate further and file fresh applications or continuation-in-part applications.

According to an aspect of the present invention, a student who is registered or participates in the class that is following the method and process of the present invention individually, and preferably irrevocably, assigns to the class instructor and/or the institution conducting the class in innovation/intellectual property all rights and title to any intellectual property that results from that student's participation in the class and contribution thereto. Such assignment may be on a royalty-bearing or non-royalty bearing basis depending on what the institution determines. The learning institution may, and preferably does, require assignment of any rights as a pre-condition to allow the subject student register for and contribute to and participate in the course in innovation that follows the present invention. The institution or the instructor may retain full ownership and rights to any intellectual property that flows from the class in innovation and its protection via intellectual property attainment taught at that institution, or they may agree to share in accordance with a contractual agreement between the instructor and the institution (and/or they may be individually or mutually obligated to share or cede ownership and rights to another entity with which the institution and/or the instructor has a relationship or obligation to). Optionally, the named inventors, drawn from the student body of the class involved, of any patent or similar intellectual property right may have a right to revenues should the intellectual property achieved so generate, or they may not, depending on the pre-condition set by the institution to allow the student register for and participate in the class.

According to an aspect of the present invention, a student who is registered or participates in the class agrees as a pre-condition to maintain confidential what is conceived or disclosed as part of that class-work, and the innovation and inventive output/activities of the class are maintained confidential and do not constitute a public disclosure or use, at least until an appropriate application seeking patent protection or the like is filed.

According to an aspect of the present invention, the institution and/or the instructor (and/or any other entity with which the institution and/or the instructor has a relationship or obligation to) retain control and ownership over the filing, prosecution of, issuance of, maintenance of, enforcement of, defense of, exploitation of, and use of any intellectual property or right (such as a patented invention) that arises from the class in innovation (or the like) conducted at that institution. The ownership and rights of such, and sharing (if any) between the institution and the instructor (and/or via a contractual prearrangement or agreement in existence between either or both of the instructor and the learning institution and a third entity that has rights or access to the present invention, such as an innovation company), may be determined between the institution and the instructor, and the instructor may elect to accept such an at least partial ownership of any intellectual property right as compensation for, at least in part, his or her instruction of the class at the institution from which the relevant intellectual property right or item was derived/originated.

According to an aspect of the present invention, the institution and/or the instructor (and/or a third entity that has rights or access to the present invention, such as an innovation company) may advance or enhance its business, ranking, enrollment or standing by publicizing its right to and practice of this present invention. Such may include advertising and promoting an innovation class that follows the method and process of the present invention in national and local media, and may include inclusion of the innovation class that follows the method and process of the present invention in an advertisement, recruitment, promotion and other literature of the institution. Such publicizing of the course may enhance at least one of student recruitment, student retention, revenues, reputation, endowment, award of grants and sponsorship and the like.

According to an aspect of the present invention, enrollment to and endowment of the innovation class that follows the method and process of the present invention (and/or of the institution providing that class) may be enhanced by having the class (or representatives from the class) visit the national Patent Office (for example, if in the USA, visit the US PTO in Alexandria, Virginia) to meet with examiners and leadership thereat and preferably to also conduct an interview of a pending patent, copyright or trademark application associated with that class, or based on or derived from a class of a prior semester/year associated with that same institution/course.

According to an aspect of the present invention, enrollment to and endowment of the innovation class (and/or of the business and financial success and reputation of the institution providing that class) that follows the method and process of the present invention may be enhanced by providing a class in innovation and intellectual property that follows a proprietary teaching method in accordance with the present invention and that is patented.

According to an aspect of the present invention, a student enrolled in the innovation class that follows the method and process of the present invention is assessed and scholastically graded on his or her participation in the conception of a patentable concept, and/or his or her prior art searching, and/or his or her usage of patent databases or search tools/engines such as those available via ESPACE and PAIR, and/or his or her conception of an innovative idea and/or his or her assessment of its innovation over prior art researched and known by that student or by the class as a whole, and/or his or her participation in the preparation of a patent application, and/or his or her participation in the responses to any Office Actions from the patent authority consequent on that filing (or in another patent application in an allied or relevant or analogous field or art if the term of the subject class does not last long enough for an Office Action for that particular class's own filing to be acted on/received).

According to an aspect of the present invention, students enrolled in the innovation class that follows the method and process of the present invention may be involved in the prosecution of a patent application from previous such classes that are then pending during the term of the subject class, and students in the subject class may be involved in market research and marketing/business exploitation of an innovation arising from the subject class, and/or from its predecessor classes, to include competitive analysis, infringement analysis and licensing activities.

According to an aspect of the present invention, costs such as the out-of-pocket fees and expenses (such as filing fees, maintenance fees, and legal fees) for the pursuit of intellectual property that results from and is part of the class-work and curriculum of the students enrolled in the innovation class that follows the method and process of the present invention may be funded by the class fee required to enroll or by a supplemental class fee paid by each student upon enrolling to the class and/or by royalty or other income generated by the intellectual property rights (such as patents) that are or were generated by this or prior classes that follow the method and process of the present invention and/or by sponsors such as university boosters or funds or businesses or agencies (such as law firms or foundations) interested in the teaching and promotion of innovation and intellectual property protection.

According to an aspect of the present invention, a course instructor may take an already issued patent and mask or otherwise redact its details (such as applicant details, control numbers, patent number, etc.) so that students are unlikely to be able to use a database to view the actual file history leading to issuance of the actual issued patent selected by the instructor. The course instructor can then covertly use this already issued patent and its file history as a Virtual Patent Examination learning tool whereby the instructor gives to the class the specification and claims as filed along with its drawings, as well as the associated Information Disclosure Statement and copies of any associated prior art documents, as a Virtual Patent Application and also provides, step-by step as it would play out in real-life at the likes of the US PTO, a copy of the various Office Actions (but with the documents masked or adapted/modified so that the students cannot readily go to a patent database to find that actual real file history that the Virtual Patent Application is based on). The students then prepare their proposed Response and Amendment and they are graded on their efforts and this continues through the various stages of the prosecution, step-by-step as it would play out in real life at the likes of the US PTO. In this Virtual Patent Application, students and/or the instructor can role play both the applicant and the examiner, and by the instructor having the students/class first submit their proposed Responses and Amendment (and be scholastically assessed on how well the student deploys what is being learnt in the lectures contemporaneously being given as part of the course being followed, and how well that student has researched/assessed the Office Action and any rejections therein, and how well that student proposes any amendments and/or arguments to overcome the examiner's positions) and then play out the examination process step-by-step, the students' interest level is retained and enhanced because they can see and learn how what they might do compares to what was actually done in a real, actual patent examination, and their learning and retention of the subject matter being taught is enhanced thereby.

According to an aspect of the present invention, a course in innovation and/or how to protect innovation via patenting or similar forms of intellectual property protection is offered to a class in a learning institution and the course and the teaching of the course follows the method and process of the present invention.

According to an aspect of the present invention, a business entity or equivalent makes available (such as by licensing, selling, franchising or the like) to learning institutions a course in innovation and/or how to protect innovation via patenting or similar forms of intellectual property protection and wherein the course follows the methods and process of the present invention. The business entity or equivalent may hold title to and ownership of any intellectual property that is used by the institution when offering and conducting the course or that is based on, derived from or consequential from the offering of such a course at the learning institutions.

According to an aspect of the present invention, learning by students forming a subject class and taking a course at a learning institution in innovation and/or how to protect innovation via patenting is enhanced by use by the instructor as a part of the teaching of the course of a virtual patent application comprising an application that is substantially similar to an actual patent application that has been at least partially prosecuted at a Patent Office.

According to an aspect of the present invention, learning by students forming a subject class and taking a course at a learning institution in innovation and/or how to protect innovation via patenting is enhanced by use by the instructor of the subject class of a surrogate pending application comprising a patent application arising from an earlier class that preceded the subject class and that took the course, or a similar course, at the learning institution and that is still pending at a Patent Office (such as the US PTO or the EPO) during the term of the subject class, and/or comprising a patent application in a prior art arena of interest to the subject class that is still pending during the term of the subject class. The instructor of the course may use a surrogate pending patent application as a part of the teaching of the course, said surrogate pending application of the present invention may comprise (i) a patent application arising from the course prior to the student registering and that is still pending at a Patent Office and (ii) a patent application in a prior art arena of interest to the student and that is still pending at a Patent Office.

According to an aspect of the present invention, a student seeking to take a course at a learning institution pre-assigns to the institution (or to an entity designated by the institution) his or her intellectual property rights that are based on, derived from or are consequential to that student's registration for and participation in the course

According to an aspect of the present invention, a student taking a course as part of a class at a learning institution in accordance with the methods and process disclosed herein is scholastically graded in accordance with the student's participation in the filing of a patent application where at least one student member of that class is a named inventor on the patent filing.

According to an aspect of the present invention, a method of enhancing learning at a learning institution about innovation and the protection of intellectual property is provided, the method comprising establishing a course in innovation and/or intellectual property protection at the learning institution and having a student desiring to register for the course at the learning institution assign to an entity designated by the learning institution any intellectual property right that student might otherwise achieve by reason of that student taking the course, appointing an instructor for the course, filing a patent application based an idea conceived as a result of the course being offered at the learning institution, and at least one student registered for the course being a named inventor on the application. The entity comprises at least one selected from the group consisting of (i) the learning institution, (ii) the instructor, (iii) an entity having an agreement with the learning institution and (iv) an entity having an agreement with the instructor. The student enters a contract to assign to the entity designated by the learning institution any intellectual property right that student might achieve by reason of that student being allowed register to take the course and at least a part of the scholastic grade awarded the student registered for the course is based upon that student's contribution towards the filing of the patent application. The student registered for the course may be a named inventor of the patent application filed if that student has contributed inventive subject-matter covered by its claims. The instructor may use a virtual patent application as a part of the teaching of the course and the learning institution may publicize that patent applications with a student registered for the course being a named inventor are filed as part of the curriculum of the course in order to enhance its standing and stature, revenues, recruitment and reputation. Costs associated with the course are at least partially offset by at least one of (i) income from intellectual property arising from the course established and offered at the learning institution, (ii) a fee paid by the student to register for the course; (iii) a supplemental fee paid by the student to register for the course; and (iv) a sponsor. The instructor may propose an innovation topic as part of the course and the patent application is preferably related to the innovation topic proposed by the instructor. The student preferably enters a contract to assign that student's rights to the entity, and the student entering that contract is a requirement by the institution to register for the course. The instructor may uses a surrogate pending patent application as a part of the teaching of the course to enhance learning. The student preferably agrees to hold confidential ideas and work product arising from that student taking that course for at least until a patent application disclosing the ideas and work product is filed. The learning institution may make the course available under an agreement between the learning institution and another entity regarding rights under this present invention and/or rights under intellectual property consequential on the course offered at the institution that follows the methods and process disclosed herein. For example, the learning institution may make the course available under a license agreement between the learning institution and the entity whereby the entity grants rights to the learning institution in return for consideration (such as payment) received by the entity from the learning institution. At least one of the entity and the learning institution may own and control the patent application that a student taking the course is a named inventor thereon and may own and control any patent that issues from that patent application or that claims priority to that patent application.

According to an aspect of the present invention, a course in innovation and/or the intellectual property protection of innovation is offered by a learning institution and wherein learning about innovation and the protection of intellectual property by a student taking the course is enhanced by offering in its curriculum a course in innovation and/or the intellectual property in accordance with the present invention and wherein the learning institute benefits from publicizing the course and enhances thereby at least one of student recruitment, student retention, revenues, reputation, endowment, award of grants and sponsorship.

According to an aspect of the present invention, having a student assign any intellectual property right comprises having the student enter an agreement such as a contract to assign to the entity designated by the learning institution any intellectual property right that student might achieve by reason of that student being allowed register to take the course.

According to an aspect of the present invention, a method of enhancing learning at a learning institution about innovation and the protection of intellectual property is provided, said method comprising establishing a course in innovation and/or intellectual property protection at the learning institution, having a student desiring to register for the course at the learning institution assign to an entity designated by the learning institution any intellectual property right that student might otherwise achieve by reason of that student taking the course, appointing an instructor for the course, filing a patent application based an idea conceived by that student as a result of the student taking the course at the learning institution and preferably, the instructor using a virtual patent application as a part of the teaching of the course.

According to an aspect of the present invention, a method of enhancing learning at a learning institution about innovation and the protection of intellectual property is provided, said method comprising establishing a course in innovation and/or intellectual property protection at the learning institution, appointing an instructor for the course, filing a patent application based on an idea conceived by a student as a result of the student taking the course at the learning institution and wherein at least a part of the scholastic grade awarded the student for the course is based upon that student's contribution towards the filing of the patent application. The method of enhancing learning preferably includes the instructor using a virtual patent application as a part of the teaching of the course. The method of enhancing learning preferably includes having a student desiring to register for the course at the learning institution assign to an entity designated by the learning institution any intellectual property right that student might otherwise achieve by reason of that student taking the course.

According to an aspect of the present invention, a method of enhancing learning at a learning institution about innovation and the protection of intellectual property is provided, said method comprising enhancing learning at a learning institution about innovation and the protection of intellectual property, said method establishing a course in innovation and/or intellectual property protection at the learning institution and appointing an instructor for the course and filing a patent application based on an idea conceived by a student as a result of the student taking the course at the learning institution and wherein at least a part of the scholastic grade awarded the student for the course is based upon that student's contribution towards the filing of the patent application.

These and other objects, advantages, purposes and features of the present invention will become apparent upon review of the following specification in conjunction with the drawings.

### BRIEF DESCRIPTION OF THE DRAWINGS

FIG. 1 is an example of a method and process for hands-on learning by a class of students on innovation and its protection via patenting;

FIG. 2 is an example of teaching tools in accordance with the present invention;

FIG. 3 is an example of a Virtual Patent Application in accordance with the present invention; and

FIG. 4 is an example of an exemplary relationship map in accordance with the present invention.

### DESCRIPTION OF THE PREFERRED EMBODIMENTS

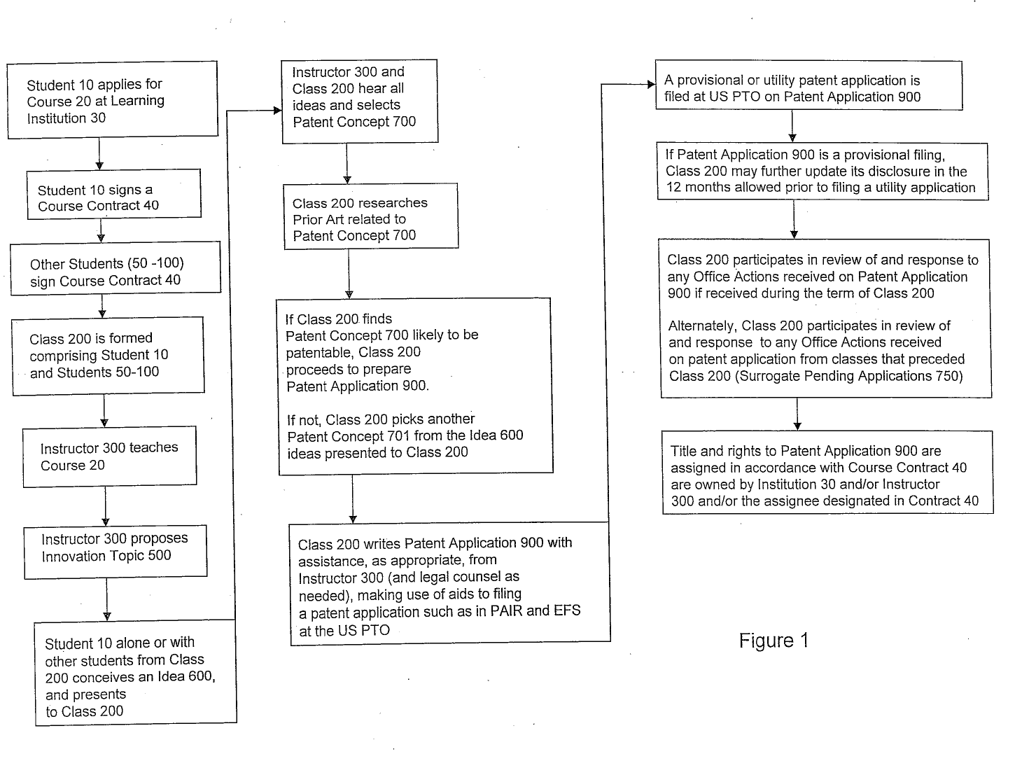

Referring now to the drawings and the illustrative embodiments depicted therein, an example of a method and process in accordance with the present invention is shown in FIG. 1

Learning Institution 30 may be a college or a university (or may be a for-profit business or institute offering training, learning or professional-development courses) that includes in its curriculum a course of study, Course 20, intended to teach innovation and how to protect intellectual property resulting from innovation. Student 10 may be an undergraduate or graduate student who is interested in learning about innovation and its protection via patenting or the like. Other students, Students 50-100, are similarly interested and together with Student 10 constitute Class 200. Note that Students 50-100 may be one other student or a plurality of additional other students. However, to be allowed join and register for Class 200, and participate in Class 200, Learning Institution 30 requires each of Student 10 and Students 50-100 to enter into a legally binding agreement or contract, such as Contract 40. Included in Contract 40 is the assignment to Learning Institution 30 (or to an entity designated by Institution 30) by any student desiring admittance to Class 200 of any intellectual property right (such as to any invention) that the student may create, conceive and/or reduce to practice at least during the term (normally a semester or two during a school year) of Class 200 (and this is binding regardless of whether or not the student signing and entering Contract 40 completes the term of Class 200). The assignment also preferably includes assignment for a period after the term of Class 200 ends of any such intellectual property right that is related to any confidential activities or information or innovation conceived, discussed or otherwise revealed or created during the term of Class 200, or for a period thereafter. Contract 40 thus includes confidentiality clauses and assignment clauses and obligations that post-date the end of the term of Class 200. Contract 40 thus binds Student 10 to assign to Learning Institution 30 all inventions related to Course 20 and what is learnt and discussed by Class 200 that are conceived by Student 10 not only during the term of Class 200 but for a post-term Confidentiality and Assignment Period (preferably at least 1 year after the end of Class 200's term; more preferably at least about 3 years thereafter and most preferably, at least 5 years thereafter). Student 10 also releases and holds harmless Learning Institution 30 from any consequence of Learning Institution 30 allowing Student 10 enter Contract 40 [to include Student 10 to represent and warrant that Student 10 will not use any confidential or proprietary information owned by a third party (without that third party's authorization) in Class 200 or its activities] and from any consequence of allowing Student 10 register for and participate in Class 200. Learning Institution 30 employs or contracts Instructor 300 to teach Course 20 to Class 200. As an incentive to Instructor 300 and/or as part of his or her compensation to teach Class 200, Learning Institution 30 may reward Instructor 300 with at least a portion of any royalties or any other monies or income generated by any intellectual property, such as a patent, that results from Class 200. Also, Learning Institution 30 may, at its election and subject to its freedom to so do under Contract 40, reward any student inventor of a patent resulting from Class 200 with at least a portion of any royalties or any other monies or income generated by any intellectual property, such as a patent, that results from Class 200 or Learning Institution 30 may elect not to so do or Learning Institution 30 may only elect to do so within a restricted time window after the end of the term of Class 200 (such as, for example, within one year or within three years). Student 10 agrees to maintain confidential the matters conceived by Class 200 and to keep confidential the activities of Class 200 so that its work product and innovations are kept confidential from the public for at least whatever time is needed to avoid any public disclosure ahead of any patenting activity.

Note that in the context of the present invention, a contract entered into by a student, such as Contract 40, has a broad meaning and may take many forms and generally encompasses, without restriction, whatever instrument or conditions Learning Institution 30 sets to allow or permit Student 10 to register for Course 20 and participate in the work and work product of Course 20 by being a student member of the student body registered to take Course 20 at Learning Institution 30. For example, Contract 40 may be embodied in the terms and conditions set by Institution 30 for registration for Course 20. Contract 40 may be a specific written or verbal agreement that each student registering for Course 20 agrees to. Contract 40 may be an explicit or an implicit agreement between Student 10 and Learning Institution 30 whereby, in consideration of the learning offered by Course 20 and in consideration of Institution 30 allowing Student 10 to register for Course 20 and to participate in Class 200 and to learn and be taught according to the method and process of the present invention, Student 10 relinquishes his or her ownership of and rights to subject matter or innovation or concepts or work product that he or she conceives, creates or contributes as a consequence of his or her registration for Course 20 and in consideration of his or her participation in Class 200, and Student 10, along with the other students constituting Class 200, assign and convey their rights to any such any subject matter or innovation or concepts or work product, without restriction, to whatever entity Institution 30 designates (such entity may be Institution 30 itself or may be another entity such as Innovation Company 2000, as described hereunder or may be the assignee or owner/controller of rights under the present invention or may be the inventor of the present invention).

Note that in the context of the present invention, registering a student to take a course has a broad meaning and generally encompasses, without restriction, allowing that student join, attend, learn from, contribute to and/or participate in a class or activity associated with a course offered at a learning institution, or the like. Typically, other students will be registered also for the class, but not necessarily; a class can consist of only one student. Also note that in the context of the present invention, appointing an instructor for a course has a broad meaning and generally encompasses, without restriction, providing a teacher or lecturer or any form of instructor to teach the course and, preferably, to assess and grade the progress of the students in a class that are taking the course. Note that in the context of the present invention, innovation and/or intellectual property protection have broad meaning and they generally encompass, without restriction, their normal meaning in existing art and practice. Note that in the context of the present invention, learning institution has a broad meaning and generally encompasses, without restriction, colleges and universities; training institutions; distance learning entities including institutions and universities and entities offering video and/or WEB-based educational services, courses and services; short-courses and/or seminars and/or professional or personal development offered by professional societies and organizations; and short-courses and/or seminars and/or professional or personal development offered by companies or governmental agencies.

Once Contract 40 is signed or otherwise entered into or committed to by all students allowed register for and participate in Course 20, the term of Class 200 commences. Instructor 300 typically lectures once or twice per week, and also holds a work-shop at least once per week (though naturally this schedule and format can vary depending on the circumstances involved). In the lectures, Instructor 300 teaches the theory, rudiments and principles of innovation and ideation, and also teaches what is required to protect intellectual property. The work-shop is primarily used for brainstorming and other innovation stimulating techniques and for progressing the preparation and filing of the Class 200 patent application (or patent applications of there are more than one prepared and filed by Class 200).

Preferably, Instructor 300 proposes a topic, Innovation Topic 500, or a restricted set of topics, for Class 200 to focus on in its innovation efforts. Class 200 may be students drawn from many faculties and disciplines such as arts and literature students or engineering/science students or business/law students or medical students, and so the Innovation Topic 500 proposed by Instructor 300 may be a general one (for example, Class 200 may be asked to innovate in furniture or in toys or in rain wear or in seats) or may be a specialized topic (for example, Class 200 may be asked to innovate in office chairs or may be asked to innovate a ladder or may be asked to innovate in a trade name for a garden tool). Instructor 300 may choose to use an innovation topic from a previous class and challenge Class 200 to come up with a further innovation (whereupon, the patent filing resulting from Class 200's efforts or work product may be a continuation-in-part of an already filed application from an earlier class that precedes Class 200). Instructor 300 may choose to use as an Innovation Topic 500 a topic at the request of, or of potential interest to, a potential or actual sponsor or supporter or endower of Learning Institution 30. For example, a topic of interest to a local industry or company may be chosen or a topic may be chosen (such as in the Homeland Security arena or in energy conversation) of interest to national agencies or foundations such as the US Department of Energy, the US Department of Homeland Security, DARPA, the Ford Foundation and the like. Optionally, the Learning Institution 30 and/or Instructor 300 may have an arrangement or an agreement or a contract with such a sponsor whereby the sponsor underwrites some or all of the costs associated with Class 200/Course 20 at Learning Institution 30 in return for access to intellectual property generated as part of Course 20 by Class 200 or by its predecessor classes or successor classes.

Having been presented with Innovation Topic 500, each student or sub-group/team of students is given a time period to conceive patentable topics related to and relevant to Innovation Topic 500. Each student or student team conceives an innovation, Idea 600, and researches it to a level suitable for presentation to and discussion/evaluation by the student body of Class 200 and its instructor, Instructor 300. These student-generated ideas reported to Instructor 300 as ideas for consideration for patenting, preferably as written

reports/proposals/disclosures/presentations, are marked “Confidential”, so that they can be circulated to other students and to other evaluators as appropriate and held confidential under Contract 40. Student grades in Class 200 can be impacted by how well the Idea 600 concept proposal is researched, prepared and presented, and how it is ranked on novelty, newness and utility compared to ideas/innovations from other students in Class 200, and by how well Idea 600 stands apart from and is distinguished over the prior art. Student scholastic grades or marking or credits or class ranking in Class 200 can also be impacted by how well the Idea 600 concept proposal might translate into a commercial revenue generator or stream for Institution 30 and/or for any owner/licensee of a patent that covers in its claims Idea 600.

Once the various Idea 600 innovations have been prepared and presented to the student body and to Instructor 300, one (or more than one if resources are available and/or the quality of the Idea 600 conceptions so warrant) of the Idea 600 innovations is selected as Patent Concept 700, preferably by Class 200 itself with guidance and instruction from Instructor 300. Class 200 next receives teaching from Instructor 300 on how to write and prepare for filing a Patent Application 900 based on selected Idea 600 that is the basis for Patent Concept 700. Individual students or teams of students may be tasked to use INTERNET search engines, including those such as on the US PTO Web-site at www.uspto.gov or web-sites associated with the European Patent Office such as www.espacenet.com to establish whatever prior art might exist relevant to Idea 600 so that an Information Disclosure Statement for Patent Application 900 can be compiled. In compiling and filing Patent Application 900, use is preferably made of aids to filing of patents such as the Electronic Filing System (EFS) available via the US PTO via http://www.uspto.gov/ebc/efs/index.html. Students may use the likes of the Public Application Information Retrieval (PAIR) available from the US PTO via http://portal.uspto.gov/external/portal/pair to review and learn from the prosecution histories of prior art relevant to Idea 600. Students may learn from Instructor 300 how to use such tools and databases in preparing Patent Application 900, and students can be graded by Instructor 300 according to how these perform in their assignments.

As the preparation towards Patent Application 900 progresses, the prior art research conducted by students from Class 200 may reveal that prior art may exist that likely would be considered to render low the chances of having subject matter of value issue from a patent application based upon selected Idea 600/Patent Concept 700. In such a circumstance, the Instructor 300, preferably working with Class 200 so that the learning of the student body of Class 200 is enhanced, may elect to select a different Idea 600 from the roster evaluated by Class 200 and Class 200 then researches the newly selected Idea 600 as new Patent Concept 701 as its candidate for Patent Application 900.

Once Class 200 has written and prepared Patent Application 900 [with assistance as needed from Instructor 300, who himself or herself may contribute inventive subject matter and may himself or herself be a listed inventor on Patent Application 900, and with a contractual prearrangement or agreement in existence between Instructor 300 and Learning Institution 30 (and/or with a contractual prearrangement or agreement in existence between either or both of Instructor 300 and Learning Institution 30 and a third entity that has rights or access to the present invention, such as Innovation Company 2000, as described below) regarding ownership of rights by Instructor 300 to any inventive contribution made by Instructor 300 to Patent Application 900 and/or assignment by Instructor 300 of those rights to Institution 30 or to its designee], filing of Patent Application 900 may proceed. In this regard, assistance may be rendered by a legal department of Learning Institution 30 or by an outside law firm in terms of the formalities of filing an application at the likes of the EPO or the US PTO. For economy and efficiency, electronic filing such as via the EFS system at the US PTO is preferred. The student or students who have inventively contributed to the claimed subject matter of Patent Application 900 (along with Instructor 300 in the event he or she has also inventively contributed to Patent Application 900) sign whatever filing papers and assignment papers are appropriate, including any under Contract 40, and Patent Application 900 is filed at a patent granting authority/Patent Office such as the US PTO or at the EPO or at both or as a PCT WIPO application.

Typically, Instructor 300 and Learning Institution 30 will decide whether to file Patent Application 900 as a provisional application or as a utility application, and whether to file nationally only or internationally/overseas such as via a PCT (Patent Cooperation Treaty) application. For those applications generated from classes in US colleges and universities, Patent Application 900 will be typically filed as a provisional filing to allow Class 200 and/or a successor class continued opportunity to add to the innovation as filed during the 12 month period allowed before a utility application need be filed to preserve the priority date of the provisional filing. This also allows Learning Institution 30 and/or Instructor 300 to further assess whether to expend the further expenditure to convert from provisional to utility, and it allows Class 200 to conduct further prior art searches and/or innovate further/develop the disclosure further, and to modify the application according to what might be learnt/further developed.

Since most classes at third level teaching institutions such as colleges and universities last one or two semesters at the most, it is unlikely that Class 200 will receive an Office Action such as from the US PTO relating to Patent Application 900 during the term of Class 200. As indicated above, filing Patent Application 900 as a provisional allows scope for the class to further develop Idea 600 and to file further provisional filings on Patent Application 900 during Class 200's term, and so filing Patent Application 900 as a provisional application is preferred as it enhances the learning and grade assessment opportunities for the students of Class 200.

Since however it is unlikely that Class 200 will receive an Office Action such as from the US PTO relating to Patent Application 900 during the term of Class 200, Instructor 300 may select an already on-file patent application from a class that preceded Class 200 (and that filed a patent or trademark or copyright application based on Course 20 or a related course at Institution 30, or at another entity) and use its file history as a learning tool for Class 200/Course 20. For example, should an Office Action from the likes of the US PTO relating to an already on-file patent application from a class that preceded Class 200 be received during the term of Class 200 (or be received ahead of the start of the term of Class 200), then Instructor 300 can make response to that Office Action by Class 200 a part of the students' learning and academic grading. Since there is typically the likes of a three month to six month time period allowed for response to an Office Action, Instructor 300 can also choose to hold off response to those Office Actions relating to classes that preceded the subject Class 200 received a month or two or three, or the like, before the term of subject Class 200 commences so that response by Class 200 to those Office Actions arising from filings by prior, preceding classes can be part of Class 200's learning from Course 20. Where there are no such Office Actions readily available relating to an already on-file patent application from a class that preceded Class 200, or in addition to such, Instructor 300 may choose an Office Action from a still pending other patent application, preferably one in the prior art arena relevant to Patent Application 900. Preferably, Instructor 300 chooses an Office Action (Surrogate Pending Application 750) that is yet to be responded to by the applicants involved, and class assignments can be given to students of Class 200 to compose their Responses and Amendments to the Office Action. Then, Instructor 300 can compare what the students of Class 200 would have responded for Surrogate Pending Application 750 with the Response and Amendment actually submitted by the applicant (or by the applicant's representatives) to the US PTO during the actual prosecution of the actual patent application that Surrogate Pending Application 750 is based upon, should this occur during the term of Class 200, so that Class 200 can gauge and learn from how they might have responded compares to how the Office Action was actually responded to in real-life at the US PTO.

Alternately, Instructor 300 may take an already issued patent and mask or otherwise redact its details (such as applicant details, control numbers, patent number etc.) so that students of Class 200 are unlikely to be able to use a database to view the actual file history of the selected already issued patent. Instructor 300 can then use this already issued patent and its file history as a Virtual Patent Examination learning tool as follows. Instructor 300 gives to Class 200 the specification as filed along with its drawings and prior art documents in the form of a Virtual Patent Application 1000 and also gives to Class 200 a copy of the First Office Action (but with these documents masked or adapted so that the students cannot readily go to a patent database to find that actual real file history that Virtual Patent Application 1000 is based on). Optionally, Instructor 300 can choose an older issued patent that predates the availability of file histories readily online via the likes of PAIR at the US PTO and by so doing, even further reduce the opportunity for a student to independently discover and access the actual file wrapper/history of the issued patent that Virtual Patent Application 1000 is based upon. The students then prepare their proposed Response and Amendment to the First Office Action and they are graded on their efforts. Instructor 300 next shares a copy (redacted/modified and masked as before so as to be covert and not readily recognizable to the students so that the students do not independently search to find the actual file history) of the actual Response and Amendment actually submitted by the actual applicants to the First Office Action during prosecution of the actual issued patent that Virtual Patent Application 1000 is based upon. Instructor 300 then shares the Second Office Action actually issued by the examiner in the US PTO with Class 200 and the students submit their proposed Response and Amendment to the Second Office Action, are graded accordingly, and Instructor 300 shares with Class 200 the further actual Response and Amendment to the Second Office Action actually submitted during prosecution of the actual patent that Virtual Patent Application 1000 is based upon. In such manner, Instructor 300 can have Class 200 experience in days or weeks what normally is only experienced over a couple of years or more during prosecution of a patent application at the likes of the US PTO. Instructor 300 can choose to have the Virtual Patent Application 1000 based on a file history that may include a restriction, rejections for anticipation and/or obviousness over prior art, an interview with the examiner involved and claim amendments and arguments to overcome rejections for indefiniteness and/or prior art. Thus, contemporaneous to them learning of these concepts in the lecture hall, students can experience an actual real-life patent prosecution through to allowance (or at least partially through its prosecution at a Patent Office) via Virtual Patent Application 1000, and do so in a manner that allows a student see and learn from how he or she might have responded/reacted to an Office Action/patent prosecution history compared to what actually happened in real-life.

A further learning benefit of the Virtual Patent Application 1000 is that the students such as Student 10 and/or Instructor 300 can role play both the applicant and the examiner, and then can learn from and assess their effort by comparison to what actually happened/transpired in the actual prosecution of the issued patent that Instructor 300 based Virtual Patent Application 1000 upon.

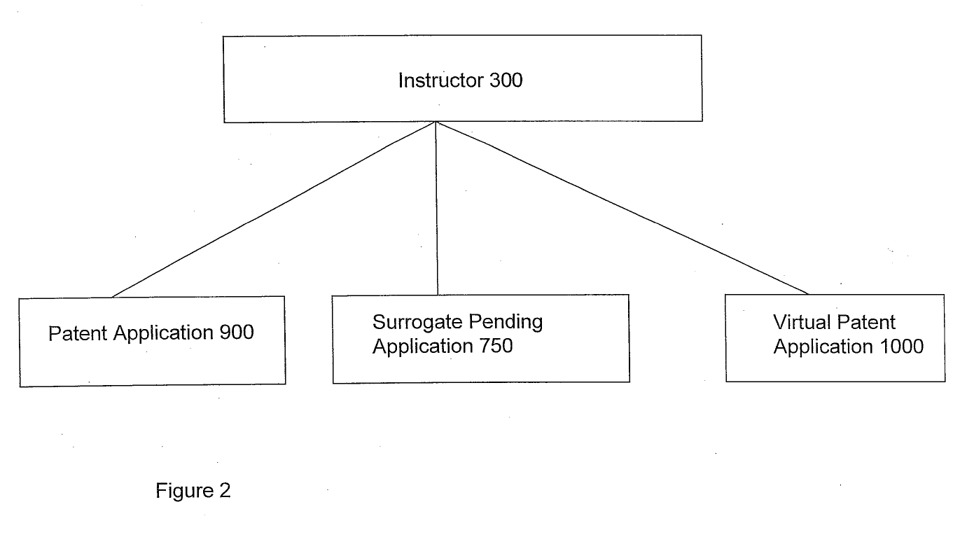

The teaching tools available to Instructor 300 are summarized in FIG. 2. Instructor 300 may utilize one, some or all of Patent Application 900, Surrogate Pending Application 750 and Virtual Patent Application 1000 to enhance the learning experience of Student 10 and of the other registered students of Class 200 that constitute its student body to enhance the learning experience of Class 200 when taking Course 20. The choice of which to use may be influenced by the timing of actions and transactions at, for example, the USPTO. In this regard, Virtual Patent Application 1000 may be a preferred tool. Virtual Patent Application 1000 being preferably based on an already prosecuted and issued patent, it can be used by Instructor 300 at any time or at any pace suited to the term, schedule and needs of Class 200. Note that Virtual Patent Application 1000 need not necessarily be an issued patent; it can be an application that went through several office actions and may have been abandoned, or it may still be pending but its prosecution is mature (for example, it may have received a Final Office Action and may be on Appeal or have entered a Request for Continued Examination, RCE, filing). Also Instructor 300 can tailor the choice of whatever issued patent to base Virtual Patent Application 1000 upon to the skills and needs of Class 200, and Instructor 300 can base Virtual Patent Application 1000 on an issued patent to include amendments, interviews and rejections that may challenge, accelerate and/or enhance Class 200's learning. Also, Instructor 300 can elect to base Virtual Patent Application 1000 on an overseas or foreign issued patent or mature pending application (for example, a European Patent prosecuted through and issued by the EPO if Class 200 is being taught in a North American learning institution) so as to enhance learning. And Instructor 300 can elect to choose an issued patent that went through an appeal to the Board of Appeals at the USPTO or that went through a reexamination at the USPTO or that went through observations or opposition or appeal at the EPO so as to further enhance learning by Class 200.

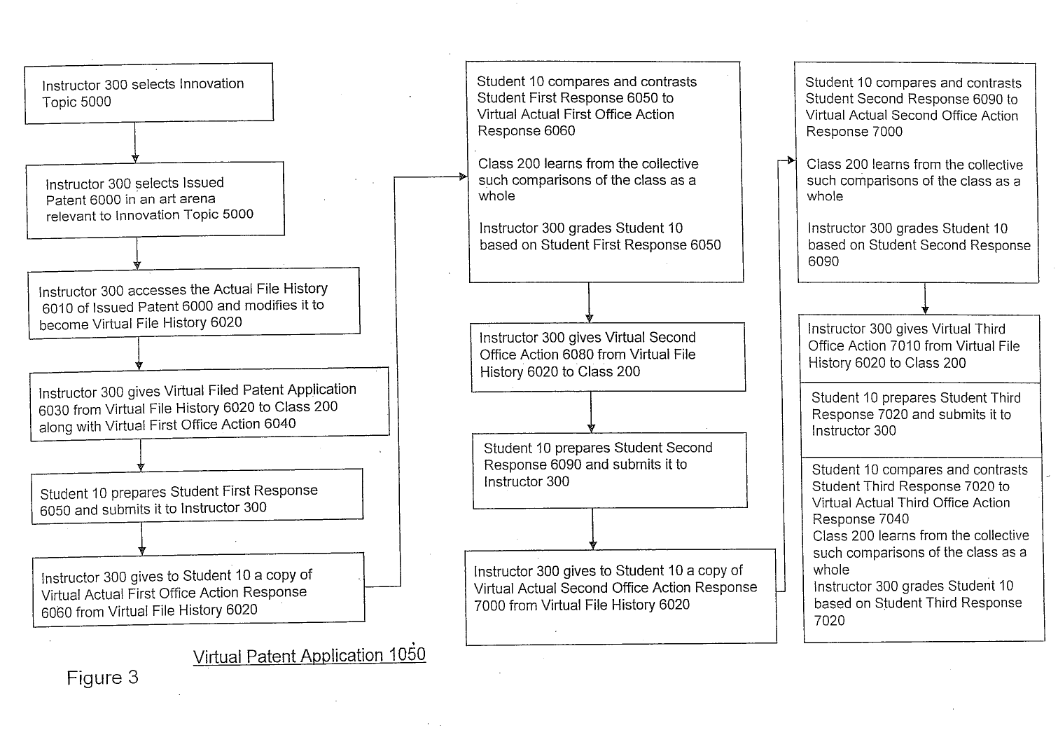

An illustrative embodiment of an exemplary Virtual Patent Application process is shown in FIG. 3. At the start of the term of Class 200, and to initiate Virtual Patent Application 1050, Instructor 300 selects an Innovation Topic 5000 for use by Class 200 as a topic for the students to focus their innovation efforts around and about. Selection of Innovation Topic 5000 and presentation to Class 200 has several advantages. Experience has shown that it is challenging to innovate in a vacuum and it is especially challenging when there is a diverse, inexperienced class of students involved. Thus selection of Innovation Topic 5000 enables the individual students and student body as a whole constituting Class 200 to channel and focus their studies, efforts, talents and work product onto a specific, pre-defined and selected product or art arena. This has the further advantage that the grading of individual students in Class 200 can be against the backdrop of innovation in a common topic or arena. A further advantage of selection of Innovation Topic 5000 by Instructor 300 is that Instructor 300 can select and tailor Innovation Topic 5000 to specific goals, objectives or needs. For example, if Class 200 comprises a class of students drawn from a particular company or industry-sector, then Innovation Topic 5000 can be tailored to be of interest to or of use to that particular company or industry-sector. Similarly, if Institution 30 is in a region with particular company or industry interests (for example, in the West Michigan area close to Grand Rapids Mich., USA, office furniture is a particular company and industry interest or close to Detroit Mich., USA, automobile parts are a particular company and industry interest, or close to Everett, Wash., USA, airplane seating is a particular company and industry interest), then Innovation Topic 5000 may be selected to suit such particular company or industry interests, and thereby enhance relevance of Course 20 to the local community, enhance student recruitment and interest, and enhance support by local and national industry and companies such as by sponsorship and by their willingness to allow students from Class 200 visit their development facilities as part of the curriculum of Course 20 and/or such as by making their employees/executives available to participate in the teaching/learning of Course 20/Class 200 (for example, an executive or technologist from a local industry or company may present to Class 200 to enhance the learning of Class 200 about Innovation Topic 5000 in particular, and innovation in general). Innovation Topic 5000 may be chosen to be of particular relevance or interest to Institution 30. For example, it may be a product or arena where Institution 30 has particular reputation, study course, curriculum or experience (for example, robotics at Carnegie-Mellon University in Pittsburg, Pa., USA) or where Institution 30 has existing intellectual property [such as from patent filings made by preceding classes to Class 200 taking Course 20 (or its predecessors) at Institution 30].

Instructor 300 next selects an issued patent (or an at least partially prosecuted, and preferably, a maturely prosecuted patent application), Issued Patent 6000. The file history/file wrapper of Issued Patent 6000, Actual File History 6010, is obtained by Instructor 300 (this may be publicly available such as at the US PTO and available via PAIR or more preferably, is not available via PAIR and made available to or obtained by Instructor 300/Institution 30 such as from the patent assignee or owner). Most preferably, Actual File History 6010 is not readily traceable via database searching by others such as Student 10 or others in Class 200. Issued Patent 6000 is preferably selected to be relevant to Innovation Topic 5000 and/or to be illustrative of whatever aspect or aspects of patenting Instructor 300 desires to emphasize to Class 200. For example, if Innovation Topic 500 is “Use of Camera Vision in Vehicles”, then U.S. Pat. No. 5,550,677 can be chosen by Instructor 300 as Issued Patent 600 (and the '677 patent has the further advantage that its Image File Wrapper is not publicly available on the PAIR web-site at the US PTO).

Instructor 300 next modifies or adapts Actual File History 6010 to create Virtual File History 6020. Virtual File History 6020 parallels and is similar to Actual File History 6010 but items in Actual File History 6010 are removed or changed to mask Virtual File History 6020's derivation from Actual File History 6010 so that students from Class 200 cannot readily access Actual File History 6010 themselves. For example, titles, names of inventors, assignees, examiners, representatives and the like are changed in Virtual File History 6020. Control numbers, dates and similar traceable items are also changed. Text changes may be also made to make database tracing more difficult. For example, “vehicle” in Actual File History 6010 may be changed to “automobile” in Virtual File History 6020 or “vehicle light” in Actual File History 6010 may be changed to “automobile lamp” in Virtual File History 6020 so as to help make Virtual File History 6020 covert with respect to Actual File History 6010. In this regard, Actual File History 6010 may be scanned into a computer, and software tools such a Adobe Acrobat and Microsoft Word may be used by Instructor 300 to transform and modify Actual File History 6010 into Virtual File History 6020, but preferably still preserving the style, content and format of Actual File History 6010 in Virtual File History 6020 so that students of Class 200 using Virtual File History 6020 as part of Virtual Patent Application 1050 access the various papers in Virtual File History 6020, as released to them step-by step in Virtual Patent Application 1050, in a style and format that is the same, or is substantially the same, as in Actual File History 6010.

Once Instructor 300 has prepared Virtual File History 6020, Instructor 300 gives the virtual application as filed, Virtual Filed Patent Application 6030, to Class 200. Virtual Filed Patent Application 6030 includes the drawings and specification, the filing date, any relevant priority dates or filings, and an accompanying Virtual Information Disclosure Statement 6035 (preferably, along with copies of prior art cited therein).

Instructor 300 also gives to Class 200 a copy of Virtual First Office Action 6040 from Virtual File History 6020. Each student in Class 200 now has an application as filed (Virtual Filed Patent Application 6030) and a virtual Office Action (Virtual First Office Action 6040). Student 10, working alone or with a team of other students, reviews Virtual Filed Patent Application 6030 and Virtual First Office Action 6040 and prepares his or her proposed response and amendment (Student First Response 6050) to Virtual First Office Action 6040. Student 10 thus gets an opportunity to deploy and practice what is being taught in lectures and in textbooks in terms of how to prosecute a patent application and do so in a manner that parallels and mimics an actual real-life patent prosecution.

Note that optionally, and after Instructor 300 gives Virtual Filed Patent Application 6030 to Class 200, Instructor 300 can elect to withhold the Virtual First Office Action 6040 and have Student 10 (or other students) role play a patent examiner and then, when student 10 (or other students) has drafted his or her Student First Office Action 6085 (and be scholastically assessed or graded thereon), Instructor 300 can give Virtual First Office Action 6040 to Class 200.

Instructor 300 reviews Student First Response 6050 and preferably, also reviews the collection of similar student proposed responses and amendments to Virtual First Office Action 6040 with Class 200 as a whole.

Instructor 300 then gives to Class 200 a copy of Virtual Actual First Office Action Response 6060 that is the covert version of the actual first response and amendment submitted by the actual applicant(s) to the US PTO (or equivalent Patent Office) in File History 6010 in response to the actual First Office Action.

Student 10 compares and contrasts what he or she proposed in Student First Response 6050 to Virtual Actual First Action Response 6060 and Class 200 learns from the collective such comparisons of Class 200 as a whole. Learning by the students is enhanced by such comparison and contrasting to a real-life response to an actual Office Action.

Instructor 300 may scholastically assess or grade Student 10 on his or her Student First Response 6050 and Student 10 can readily assess how future grades might be improved by comparing Student First Response 6050 to Virtual Actual First Action Response 6060.

Next, and as shown in FIG. 3, Instructor 300 gives to Class 200 a copy of Virtual Second Office Action 6080 from Virtual File History 6020 and Student 10 prepares Student Second Response 6090 and submits it to Instructor 300, and is graded on his or her submission. Instructor 300 then gives to Class 200 a copy of Virtual Actual Second Office Action Response 7000 that is the covert version of the actual second response and amendment submitted by the actual applicant(s) to the US PTO (or equivalent Patent Office) in File History 6010 in response to the actual Second Office Action.

Student 10 compares and contrasts what he or she proposed in Student Second Response 6090 to Virtual Actual Second Action Response 7000 and Class 200 learns from the collective such comparisons of Class 200 as a whole. Learning by the students is again enhanced by such comparison and contrasting to a real-life response to an actual Office Action.

As further shown in FIG. 3, the process can continue into a third Office Action (or more) if such is pertinent to the learning by Class 200 and/or is available in Virtual File History 6020. Also, at any stage, any student can role play the patent examiner and have his or her Virtual Office Action effort submitted to Instructor 300 (and be graded by comparison to the actual responses covertly lifted from File History 6010) ahead of release to Class 200 by Instructor 300 of Virtual Actual First Action Response 6060 or Virtual Actual Second Action Response 7000 or Virtual Actual Third Action Response 7040.

Note that Student 10 (and the other students in Class 10) may be required (such as in Contract 40) not to attempt to find File History 6010 by searching for it using Virtual File History 6020, or by using any of the workings and activities of Class 200, or in any other way seek to identify and directly access File History 6010. Such agreement by Student 10 may be on an honor system and/or may be in writing, and may be a condition of participating in Class 200 and being graded in that class.

Virtual Application 1050 allows Class 200 experience in a period as short as one day the practice of a patent prosecution that otherwise may take months to years to experience. For example, Learning Institution 30 may be an institute or organization that offers short-courses, workshops or seminars in innovation and in its protection via the likes of patenting. Course 20 may be a half-day or whole-day intensive course offered by Learning Institution 30 on behalf of, for example, the likes of the Society of Automotive Engineers (of Warrendale, Pa.) for its members or be an educational development course offered in-house by a company or organization for its employees. Thus the term of Class 200 may be as short as half a day, and so Virtual Application 1050 is of particular value in such circumstances.

Since examination at the likes of the US PTO of filed Patent Application 900 will likely continue/may only begin beyond the end of the term of Class 200, prosecution of Patent Application 900 may be conducted by Learning Institution 30 (or by its representatives) and/or by Instructor 300 (or by Instructor 300's representatives) beyond the end of the term of Class 200. However, and assuming timings work out, prosecution of Patent Application 900 may be conducted by a successor class to Class 200 that is taking Course 20 at Learning Institution 30. To enhance the learning experience, and preferably, Course 20 includes a field trip by Class 200 to a national patenting agency/Patent Office such as the US PTO in Alexandria, Va., USA. During such a visit, students may have the opportunity to tour the facilities available and to meet with representatives of the examination bureau and with leadership of the authority/Agency. Also, and where the opportunity is possible due to an open Office Action on a patent application related to a Course 20 (such as a patent filing generated by a preceding class to Class 200 at Learning Institution 30) that is yet-to-be-responded to, an Interview by Class 200 or by the students from Class 200 may be conducted with the patent examiner involved. In lieu of a face-to-face interview, a telephonic interview may be contemplated if travel to the likes of the US PTO by Class 200 or students from Class 200 is not possible.

Also to enhance interest and learning by students and/or by potential sponsors, Class 200 may research the intellectual property portfolio of local industry and companies and undertake off-site/off-campus visits (or invite visits by such companies to campus) to discuss what local industry and companies are developing/have developed. Instructor 300 may tailor Innovation Topic 500 to optimize the potential of cooperation between the learning institution (for example, Hope College of Holland, Mich., USA) and a local company (for example, Herman Miller of Zeeland, Mich., USA if office furniture be Innovation Topic 500 or Gentex Corporation of Zeeland, Mich., USA if smoke detectors be Innovation Topic 500). Student 10 may intern at or be a co-op student at a local or national company relevant to Innovation Topic 500 so as to enhance his or her learning from Course 20 and/or to enhance that company's support or sponsorship for Course 20.

Various forms of ownership of the rights under the intellectual property such as patents generated by or derived from Class 200 and the conductance of Course 20 at Learning Institution 30 in accordance with the methods and process of the present invention are contemplated in the present invention. As indicated above, students registering and participating in Course 20 are required to assign or otherwise relinquish their creative or inventive or patent or other entire intellectual property rights to Learning Institution 30 and/or to Instructor 300 and/or to any designee of Learning Institution 30 (such as Innovation Company 2000) for any intellectual property protection or right arising from that student's registration for and participation in Class 200. Thus, Student 10, as a condition to and in consideration of registering for Course 20 at Learning Institution 30 and in consideration of participating in Class 200, assigns to an entity designated by Learning Institution 30 (that may be Learning Institution 30 itself or that may be another entity, as described below) any intellectual property right that Student 10 might achieve by reason of and consequent on Student 10 being allowed register for, and to take, Course 20.

This is in consideration of the learning and tuition such students (such as Student 10) obtain via their participation in Class 200 and via their participation in a course that applies and follows the innovation learning and teaching method and process according to the present invention as pursued in Course 20. Preferably, and by mutual agreement between Instructor 300 and Learning Institution 30 or by individual or mutual obligation, the patent filings and other intellectual property filings and rights from Class 200/Course 20 may be assigned to and owned by an Innovation Company 2000 (that may be partially or wholly owned and/or controlled by Instructor 300). Innovation Company 2000 may be the partial or whole owner and controller of any rights under the present invention. Instructor 300 may be an employee of, owner of, affiliate of, licensee of, franchisee of or otherwise associated with Innovation Company 2000. Patent filings and the like made by and through Innovation Company 2000 may be economically made assuming that Innovation Company 2000 qualifies as a small-entity under the fee structure for filings at the US PTO. Learning Institution 30 may have a contractual arrangement with Innovation Company 2000 whereby Innovation Company 2000 receives the assignments, titles and rights to inventions and other intellectual property made under the auspices of Course 20 at Learning Institution 30 and whereby Learning Institution 30 receives services and rights, such as rights under the present invention, from Innovation Company 2000 as well as provides services to Institution 30 as agreed between Learning Institution 30 and Innovation Company 2000. The assignee of the present invention may be associated with and may be an owner or controller or shareholder of Innovation Company 2000. Also the inventor of the present invention may be Instructor 300 teaching such as, for example, as an adjunct professor or the like at Learning Institution 30 or Instructor 300 may be associated with Learning Institution 30 and may be teaching Class 200 utilizing the methods and process of the present invention by reason of an agreement or contract between the assignee of the rights under the present invention and Learning Institution 30. Also the inventor of the present invention may be a shareholder of, employee of, a controller of, or an associate of Innovation Company 2000.

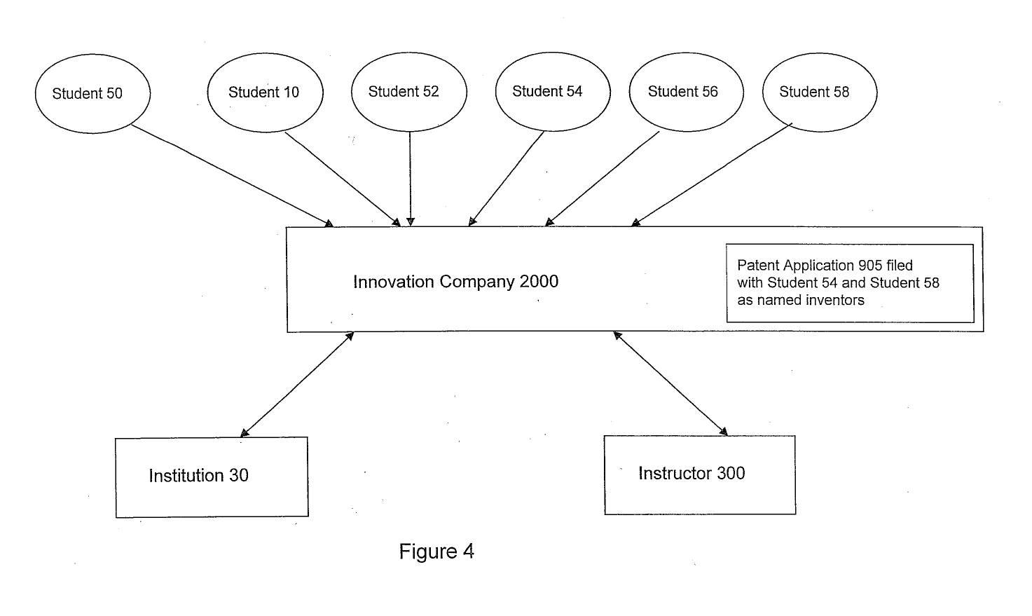

An illustrative embodiment of an exemplary relationship map is shown in FIG. 4. In this embodiment, Class 200 consists of six students, Student 10 and Students 50, 52, 54, 56 and 58. To register for Course 20 and Institution 30, each student is required by Institution 30 to assign to Innovation Company 2000 any and all intellectual property right (such as the right to apply for and own, or assign to other than Innovation Company 2000, any invention or design or copyright or trade mark) that the student achieves by reason of his or her registration for and participation in Class 200. As shown in FIG. 4, a Patent Application 905 results from the inventive effort of Student 54 and Student 58, and is filed at the US PTO with Student 54 and Student 58 as named inventor. Full title to and ownership of the inventive subject-matter of Patent Application 905 (and of any patent or patents that might issue from Patent Application 905) is irrevocably and entirely assigned to Innovation Company 2000 by Student 54 and by Student 58 when each student registered to take Course 20 (this may be via Contract 40 or by any other suitable agreement means that is binding on Student 54 and on Student 58). Innovation Company 2000 may prosecute Patent Application 905 and has an agreement, arrangement or contract with Institution 30 whereby Class 200, and its instructor, Instructor 300, are involved in, and the learning by Class 200 of innovation and its protection is enhanced by, the filing and prosecution of Patent Application 905. Institution 30 may be a franchisee or a licensee of owner or controller of the rights to the present invention, such access for Institution 30 being made available to Institution 30 via its agreement, relationship and/or contract with Innovation Company 2000 and/or with the assignee of the present invention and/or with the inventor of the present invention. Similarly, Instructor 300 may be a beneficiary, at least in part, of any revenues or value or ownership of the Intellectual Property Patent Application 905 constitutes, or may not be depending on the particular circumstances involved. Also, Instructor 300 may pre-assign any or all of his or her rights to Innovation Company 2000 in consideration of being allowed teach Course 20, and Instructor 300 may be obliged to execute an agreement or contract similar to Contract 40 in order to teach Course 20.

Innovation Company 2000 may also provide teaching aids, text books, lecture notes, audio-visual aids including videos and DVDs, course and curriculum guides, promotional material, course outlines, marking schemes, instructors, teaching aides, software, INTERNET-accessible web-sites/services, legal services, managerial services, legal services, facilities, student grading/assessment, Virtual Patent Applications, Surrogate Pending Patent Applications, distance-learning services, training, accreditation and other assistance to Learning Institution 30 and/or to Instructor 300 for the teaching of a course in accordance with the present invention. For example, Innovation Company 2000 may develop and provide a set or suite of Virtual Patent Applications in accordance with the present invention to be used in Course 20. For example, Innovation Company 2000 may develop and furnish a Virtual Patent Application or a set or suite of Virtual Patent Applications relevant to a specific Innovation Topic or set of Innovation Topics in response to request by an Instructor or a Learning Institution or an interested party such as a company or an institute or a foundation or a governmental agency or an individual. Innovation Company 2000 may file patent applications arising from Course 20 and from similar courses that follow the methods and process of the present invention, and Innovation Company 2000 may manage the estate of intellectual property developed at Institution 30, and elsewhere, according to the present invention, to include generation of revenues therefrom such as via licensing, sale of rights and collection of damages from infringers. Innovation Company 2000 may be a licensor or franchiser of rights under the present invention to Learning Institutions and to others, and may elect to grant the likes of Learning Institution 30 at least limited or restricted exclusivity to the rights under the present invention. For example, Learning Institution 30 (or another entity) may obtain from Innovation Company 2000 a geographic-based exclusivity (such as a local-area or regional-area or State-wide or a city-wide exclusivity) and/or may obtain a time-based exclusivity (such as for a period of two years or a period of five years) and/or may obtain a performance-based exclusivity (based on the returns generated to the benefit of Innovation Company 2000) and/or may obtain a type-based exclusivity (for example, exclusivity to community college or to a type of industry) and/or may obtain a subject-based exclusivity (for example, exclusivity to innovation learning in a particular field or arena such as the automotive field or aeronautics). Innovation Company 2000 may also trade mark and copyright material useful and used in teaching a course in accordance with the present invention, and make that intellectual property available to its associates and affiliates and to its licensee and franchisees, and/or Innovation Company 2000 may obtain rights to any such from, for example, the inventor and/or any assignee of the present invention. For example, Innovation Company 2000 may obtain rights to, and use, the trade name “InnoLearn”, including any such right or privilege that may be granted by the USPTO pursuant to the application (Serial Number 77073886) for registration of the trade name “InnoLearn” by the inventor of the present invention on Dec. 31, 2006. Also, the trade names “InnoTeach” and “Virtual Patent Application” may be used by the inventor of the present invention (or by others, such as Innovation Company 2000 or Learning Institution 30 or Instructor 300, by permission of the inventor of the present invention). Innovation Company 2000 (or another entity under permission from the inventor of the present invention) may also promote and advertise the methods and process of the present invention, including the practice thereof at learning institutions, and Innovation Company 2000 may establish, set and enforce specifications and standards for the teaching of a course that is in accordance with the present invention. Equipped with the methods and process of the present invention, Innovation Company 2000 may develop and implement a business model or business plan based on the present invention, and promote and promulgate it for business gain and revenue among learning institutions and other entities.

Therefore, the present invention provides a way for the principles and techniques of innovation and the protection of intellectual property arising from innovation to be taught to students at an institution such as a college or a university in a manner that enhances learning and for those students to learn how to appropriately protect the intellectual property created by innovative effort in a manner that runs contemporaneous with their academic learning.

The methods and process of the present invention allow the students learn hands-on how to conceive an invention and how to protect it through patenting. The methods and process of the present invention allow the students learn this at an accelerated pace that is in tandem with and contemporaneously parallels what those student are learning via lectures and text-books, and in a timeframe that allows them see and learn by the creation of and the filing of an actual patent application how what is taught in lectures and in text-books translates into practice. The learning is thus practical, intuitive and instructive and the student is scholastically graded and assessed, and credits and grade points can be awarded, based on performing tasks (such a prior art searches and responses to actual Office Actions) that normally would not be available to a student taking a course in innovation at a typical college or university. The Virtual Patent Application 1000 of the present invention allows an instructor covertly playback to the class being instructed an actual patent prosecution and allows the students respond as if they were the applicant and/or the examiner in the patent prosecution itself but also lets those same students see and learn step by step from what actually happened in a real-life prosecution at the likes of the US PTO. The Virtual Patent Application 1000 of the present invention greatly enhances student participation in and learning from the course in innovation, and in patenting procedures and practices, as the student can see and experience/learn from working step by step through the prosecution, and by seeing and learning from how his or her responses (and those of the class as a whole) compares to what actually happened at the US PTO during the actual prosecution of the issued patent selected for covert use in the Virtual Patent Application. The interest level of the students and their retention and understanding of the material taught can be enhanced by the instructor inviting local entrepreneurs, local business and technology leaders and local lawyers to address the class on aspects of the subject-matter being taught. The instructor also stimulates innovative activity by selecting an innovation topic for the class to generate patentable ideas about, and can further help this innovation process by organizing class field trips to local or national businesses/organizations/facilities where students can learn and experience more about the innovation topic selected by the instructor. The students learn how to use databases such as those available at the US PTO and the likes of ESPACE and similar available via the EPO (such as at http://register.epoline.org/espacenet/ep/en/srch-reg.htm), as well as the likes of the Delphion Research intellectual property network (see http://www.delphion.com/) to conduct prior art and patentability research and this learning is enhanced by the student being able to contemporaneously use what he or she is finding or learning in an actual patent filing filed by the class as part of the course-work itself, and for credit towards graduation, as disclosed and described above and in accordance with the methods and process of the present invention. Also, those students whose ideas are selected for filing into a patent application gain the added benefit of being able to so state on future resumes (provided of course that the application publishes and/or issues as a patent and/or the student is free to so cite in his or her resume under the confidentiality conditions set when the student registered for Course 20)

The institution offering a course that is conducted in accordance with the methods and process of the present invention benefits from enhanced revenues, reputation, student recruitment and student retention. Patents or other intellectual property such as copyrights or trademarks filed as a result of a course in innovation and intellectual property protection that is conducted in accordance with the methods and process of the present invention may generate future revenue for that institution via royalty income or sale of patent rights. Alumni, media, grant agencies and other external entities may view such a course in innovation and intellectual property protection that is conducted in accordance with the methods and process of the present invention to be itself innovative and this is likely to draw accolades and enhanced support and funding for the institution involved. Students may be attracted to take the course at the learning institution, and once registered may refrain from dropping out, due to the innovative nature of a course in innovation and intellectual property protection that is conducted in accordance with the methods and process of the present invention. Students may be attracted to and once registered, may refrain from dropping out also due to the enhanced interest level of students for a course that is conducted in accordance with the methods and process of the present invention. Local businesses and firms, including law firms, may help offset costs for patent filings, prosecution and maintenance due to the innovative nature of a course in innovation and intellectual property protection that is conducted in accordance with the methods and process of the present invention and/or may wish to buy options or rights to any intellectual property generated. National and local news media are likely to feature such a course as an example of an innovative teaching method, thus further enhancing that institution's reputation. Institutions or entities may enhance their reputation and revenues by obtaining at least a partial exclusivity to access right to and to use the methods and process of the present invention, such rights to include rights to any patents, trade marks or copyrights granted to the present invention or pertinent to or used by a practitioner thereof. Institutions or entities may enhance their reputation and revenues by promoting in their student recruitment literature and promotions, in their grant solicitations, in their endowment solicitations, and in their general solicitations, advertisements and literature, that such institutions or entities have access to and use of rights to the present invention, to include any promotion of any exclusive nature of such right.

Note that the examples given above to filing a patent application and its prosecution are exemplary only and the methods and process of the present invention can be applied to other intellectual property protection such as of trademarks and copyrights.

Changes and modifications to the specifically described embodiments may be carried out without departing from the principles of the present invention, which is intended to be limited only by the scope of the appended claims as interpreted according to the principles of patent law.

The embodiments of the invention in which an exclusive property or privilege is claimed are defined as follows:

1. A virtual patent application, said virtual patent application comprising:
a document comprising text and drawings;
wherein the text and drawings of said document are based on, and are substantially similar to, text and drawings of an actual patent application that has been at least partially prosecuted at a Patent Office; and
wherein the text and drawings of said document are redacted, modified or masked so as not to be readily recognizable to have been based on said actual patent application.

2. The virtual patent application of claim 1, wherein said actual patent application is issued as a patent at said Patent Office.

3. The virtual patent application of claim 1, wherein said Patent Office comprises the United States Patent & Trademark Office.

4. The virtual patent application of claim 3, wherein said actual patent application comprises part of a patent prosecution file history at the United States Patent & Trademark Office.

5. The virtual patent application of claim 4, wherein said patent prosecution file history at the United States Patent & Trademark Office includes an appeal to the Patent Trial and Appeal Board at the United States Patent & Trademark Office.

6. The virtual patent application of claim 4, wherein said patent prosecution file history at the United States Patent & Trademark Office includes a reexamination at the United States Patent & Trademark Office.

7. The virtual patent application of claim 4, wherein said patent prosecution file history at the United States Patent & Trademark Office includes a Request for Continued Examination at the United States Patent & Trademark Office.

8. The virtual patent application of claim 4, wherein prosecution of said actual patent application was abandoned at the United States Patent & Trademark Office.

9. The virtual patent application of claim 1, wherein said actual patent application is art in an area of interest to a course taught at a learning institution.

10. The virtual patent application of claim 9, wherein the text and drawings of said document are redacted, modified or masked by removal from said actual patent application of applicant details and control number so that students taking the course at the learning institution cannot readily use a database to view the file history of prosecution of said actual patent application at said Patent Office.

11. The virtual patent application of claim 10, wherein said document comprises the specification and drawings of said actual patent application.

12. The virtual patent application of claim 11, wherein said document comprises claims as filed when said actual patent application was filed at said Patent Office.

13. A virtual patent application, said virtual patent application comprising:
a document comprising text and drawings;
wherein the text and drawings of said document are based on, and are substantially similar to, text and drawings of an actual patent application that has been at least partially prosecuted at the United States Patent & Trademark Office;
wherein said actual patent application comprises part of a patent prosecution file history at the United States Patent & Trademark Office;
wherein the text and drawings of said document are redacted, modified or masked so as not to be readily recognizable to have been based on said actual patent application; and
wherein the redaction, modification or masking comprises removal from said actual patent application of applicant details and control number so that students taking a course at a learning institution cannot readily use a database to view the file history of prosecution of said actual patent application at the United States Patent & Trademark Office.

14. The virtual patent application of claim 13, wherein said document comprises the specification and drawings of said actual patent application.

15. The virtual patent application of claim 14, wherein said document comprises claims as filed when said actual patent application was filed at the United States Patent & Trademark Office.

16. A virtual patent application, said virtual patent application comprising:
a document comprising text and drawings;
wherein the text and drawings of said document are based on, and are substantially similar to, text and drawings of an actual patent application that has been at least partially prosecuted at the United States Patent & Trademark Office;
wherein said actual patent application comprises part of a patent prosecution file history at the United States Patent & Trademark Office;
wherein the text and drawings of said document are redacted, modified or masked so as not to be readily recognizable to have been based on said actual patent application; and
wherein at least one of:
(i) said patent prosecution file history at the United States Patent & Trademark Office includes an appeal to the Patent Trial and Appeal Board at the United States Patent & Trademark Office;
(ii) said patent prosecution file history at the United States Patent & Trademark Office includes a reexamination at the United States Patent & Trademark Office;
(iii) said patent prosecution file history at the United States Patent & Trademark Office includes a Request for Continued Examination at the United States Patent & Trademark Office; and
(iv) said patent prosecution file history at the United States Patent & Trademark Office includes abandonment of said actual patent application at the United States Patent & Trademark Office.

17. The virtual patent application of claim 16, wherein said document comprises claims as filed when said actual patent application was filed at the United States Patent & Trademark Office.

18. The virtual patent application of claim 16, wherein the redaction, modification or masking comprises removal from said actual patent application of applicant details and control number so that students taking a course at a learning institution cannot readily use a database to view the file history of prosecution of said actual patent application at the United States Patent & Trademark Office.

19. The virtual patent application of claim 18, wherein said actual patent application is issued as a patent at the United States Patent & Trademark Office.

20. The virtual patent application of claim 19, wherein said document comprises the specification and drawings of said actual patent application, and wherein said document comprises claims as filed when said actual patent application was filed at the United States Patent & Trademark Office.
